(19) United States
(12) Patent Application Publication
(10) Pub. No.: US 2014/0298604 A1
(43) Pub. Date: Oct. 9, 2014

(54) INTERDENTAL TOOTHBRUSH CLEANING MEANS

(71) Applicant: JOKER AG, Kerzers (CH)

(72) Inventor: Meinrad Flury, Kerzers (CH)

(21) Appl. No.: 14/352,679

(22) PCT Filed: Oct. 1, 2012
(86) PCT No.: PCT/EP2012/069361

§ 371 Date: Apr. 17, 2014

(30) Foreign Application Priority Data
Oct. 19, 2011 (CH) 01698/11

(51) Int. Cl. B08B 11/00

(52) U.S. Cl. CPC B08B 11/00
USPC 15/104.002

(57) ABSTRACT

A means consisting of a first and a second kneadable and shapeable compound to be used separately is proposed for cleaning interdental toothbrushes. The two compounds have the same basic composition, namely comprising hydroxypropylated polygalactomanan and 75% by weight to 97% by weight bound water and a liquid antiseptic solvent component, wherein the first kneadable and shapeable compound contains primarily active ingredients with a sterilizing effect, while the second kneadable and shapeable compound contains active ingredients for dental care having disinfectant and antiseptic properties. The first kneadable and shapeable compound serves to clean the interdental toothbrush and picks up the solid particles adhering to the toothbrush. It also serves to sterilize the interdental toothbrush while the second kneadable and shapeable compound contains mainly antiseptic means, such that the active ingredients are dispensed to the interdental toothbrush before its use and/or reuse. Furthermore, a device for use of the interdental toothbrush cleaning means is also proposed. This device consists of two separate containers, which are held together and in which the first and second kneadable and shapeable compounds are contained separately. Each container preferably has multiple compartments, and each container has its own closing cap, in the bottom part of which insertion openings (10) are provided, each communicating with one compartment (9). Two containers (2, 2′) are held together with their two bottoms facing one another by means of a clip-shaped holding device (4).

The present invention relates to an interdental toothbrush cleaning means.

Tooth cleaning is a practice that has been known for several hundred years. The use of toothbrushes for this purpose has also been known for a very long time, and finally preparations for cleaning teeth have also been known for much more than a hundred years. Cleaning of toothbrushes did not become really customary until the importance of hygiene was understood, which in practical terms was not until the nineteenth century. This cleaning is normally performed in a glass of water or under running water.

However, it is by no means always possible to perform such a cleaning under running water either because running water is not always available or because the available water is not of a suitable quality for this purpose. Although normal dental hygiene is usually performed in the evening or early in the morning, when one is usually at home or in a hotel, where water of a sufficient quality is available, this is hardly the situation after a noon meal and in particular when traveling. Since fiber residues remain adhering in the interdental space in particular after a meal containing meat, there is a great need for cleaning the interdental spaces. Many restaurants offer toothpicks for this purpose, but a much better cleaning can be achieved by using interdental toothbrushes. But, as already mentioned, there are often problems in cleaning such brushes.

In addition to the cleaning of interdental toothbrushes, another problem is that dental hygiene products are hardly available for interdental toothbrushes, as is otherwise customary with traditional toothbrushes. The use of interdental toothbrushes is nevertheless of enormous importance. Although traditional toothbrushes reach only approximately 70% of the dental surface, the remaining 30% is the area which is responsible for up to 80% of the caries and periodontitis. Reliable cleaning of the interdental spaces is therefore of special importance.

Even in those cases in which running water is available to clean the brush, microorganisms and bacteria that may remain adhering to the interdental brush//toothbrush during the cleaning process are removed only inadequately by the rinsing effect. Over a thousand different bacterial species are present in the mouth and these are of course also present in the interdental area. The contaminated surface of interdental toothbrushes offers an ideal breeding ground for exponential growth of pathological microorganisms, which lead to a potential health risk.

Although efforts have long been devoted to the issue of cleaning hairbrushes (one example of such an agent is known from CN 101386009), there are hardly any known agents devoted to cleaning toothbrushes. Reference is made here to the document CN 1086845 A, and no means directed specifically at cleaning interdental toothbrushes are known to exist.

Consequently, the object of the present invention is to make available an interdental toothbrush-cleaning means, which can be used without running water and which achieves an excellent cleaning effect by removing the debris adhering to the interdental toothbrush and with which agents containing an antiseptic and in particular plaque bacteria-inactivating agents that preferably also inhibit the formation of new dental calculus can also be applied to the toothbrush.

This object is achieved by an interdental toothbrush-cleaning means, which is characterized in that it comprises a first and a second kneadable and shapeable compound, which are to be used separately, such that the two compounds have the same basic composition, comprising hydroxypropylated polygalactomanan and 75% by weight to 95% by weight bound water and a liquid antiseptic solvent component, wherein the first kneadable and shapeable compound contains primarily sterilizing active ingredients, and the second kneadable and shapeable compound contains disinfectant and antiseptic active ingredients that provide dental care.

Additional advantageous embodiments of the cleaning means are derived from the additional dependent claims.

Another object of the present invention is to create a device for cleaning interdental brushes for use of the cleaning means according to the invention. Such a device according to the invention is characterized in that it has two separate containers, one each for the first and second cleaning compounds into which an interdental toothbrush can be inserted through at least one separate insertion opening for each and, having been inserted, can be brought into effective contact with the two compounds one after the other.

Additional advantageous embodiments of the device according to the invention are derived from the dependent claims of the device claim.

The interdental toothbrush-cleaning means according to the invention is first described below and then the device to be used with this interdental toothbrush cleaning means, which is illustrated in the accompanying drawing and is explained below with reference to the drawing, is also described.

The drawings illustrate the device according to the invention, in which:

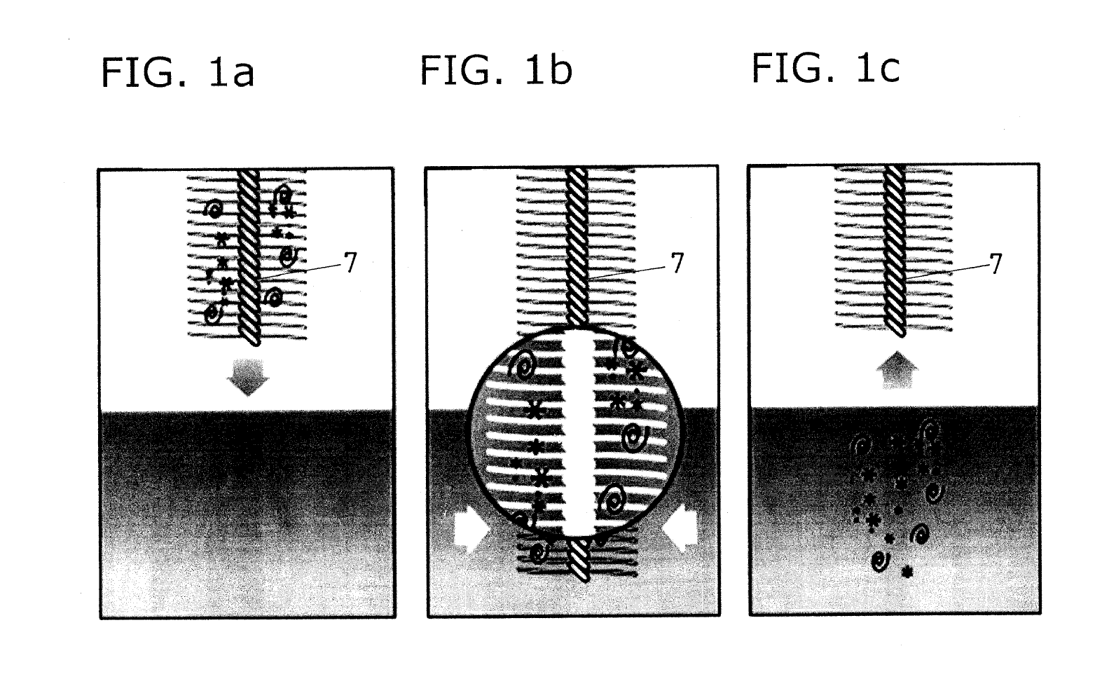

FIG. 1 shows a schematic diagram of the mechanism of action of the interdental toothbrush-cleaning means according to the invention, wherein

FIG. 1a shows the insertion of the soiled interdental toothbrush to be cleaned, and

FIG. 1b shows the transfer of the debris from the interdental toothbrush to the first mass, and

FIG. 1c shows the debris remaining in the first compound.

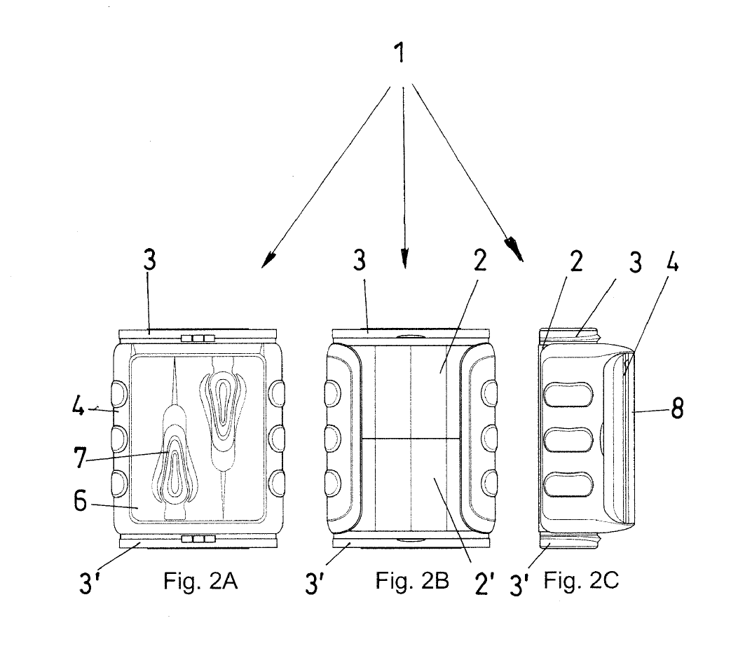

FIG. 2a shows a preferred embodiment of the device according to the invention with a view of the rear side,

FIG. 2b shows the same device with a view of the front side, and

FIG. 2c shows a side view of the same device.

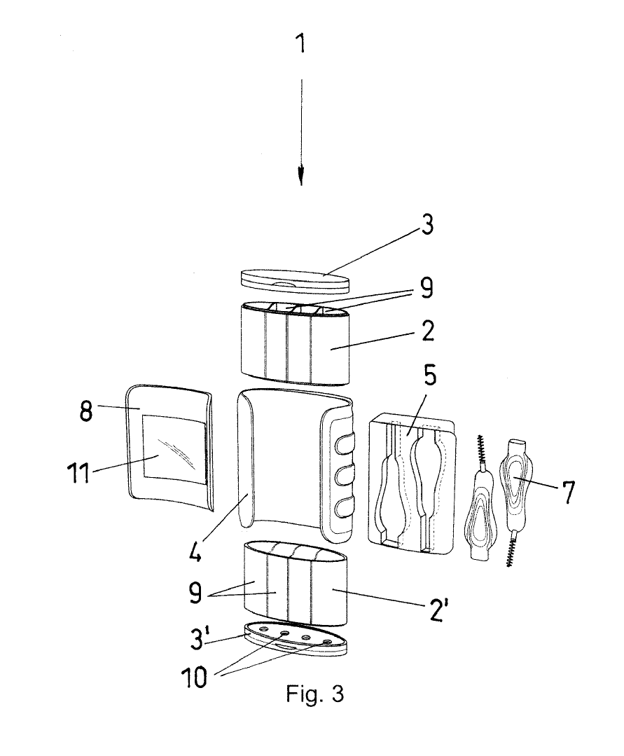

FIG. 3 shows an exploded diagram of the device according to the invention, as illustrated in FIGS. 2a-2c, and

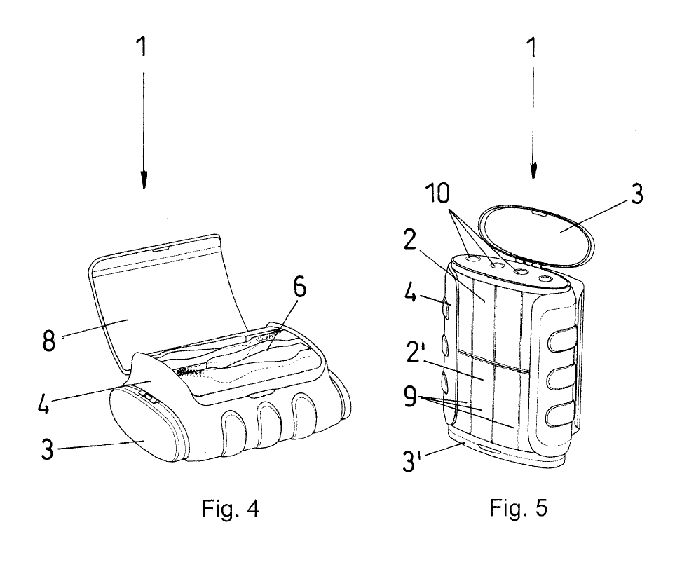

FIG. 4 finally shows the same device again horizontally in a perspective view, showing the rear side opened, while finally

FIG. 5 again shows the same device with an opened cap in a perspective view.

The interdental toothbrush-cleaning means according to the invention will first be described in detail in the description of the device according to the invention. The means comprises two shapeable and kneadable compounds that are to be used separately but belong together. These two compounds have the same basic composition. This basic composition is already known per se from EP 1373449, where the composition of the compound is specifically adjusted with the addition of the active ingredients, so that this compound is suitable as a cleaning compound, in particular for cleaning keyboards of electronic devices. Compounds having a similar consistency have also come on the market as playdough (Play-Doh). These compounds have a viscosity between 50,000 and 150,000 mPa·s. Such kneadable and shapeable compounds contain between 70% and 75% by weight bound water and solvent. Saturated monovalent alcohols are preferably used as the solvent. Examples include methanol, ethanol, etc. Such a soft, easily shapeable compound will conform to any contour. However, this compound is strongly cohesive, so that when it is extremely deformed, no residues remain behind on the surfaces to cleaned. The particles picked up by the compound remain in the compound. The particles thereby introduced are never released again due to the membrane effect of the compound, which securely encloses the particles. The above-mentioned basic compound, which contains as the active ingredient practically only the solvent, namely a monovalent alcohol or a mixture of such monovalent alcohols and thus not only has a purely mechanical cleaning effect but also has an antiseptic effect at the same time. The above-mentioned basic composition contains hydroxypropylated polygalactomanan, which, as mentioned above, is capable of bonding a very large amount of water and liquid solvent components. Guar gum and/or carob flour are suitable as the polygalactomanan. Guar gum is obtained by milling the endosperm of the guar bean, which belongs to the family of Leguminosae. The main component of guar gum is guaran, which is a polygalactomanan, i.e., a polysaccharide, as already mentioned above. Guar gum is widely used as a natural thickener and as a stabilizer in the food industry.

With the interdental toothbrush-cleaning means according to the invention, a first and a second kneadable and shapeable compound that belong together but are to be used separately, where this compound has the basic composition described above, is used in the cleaning means. In other words, the compound comprises hydroxypropylated polygalactomanan and 75% by weight to 97% by weight bound water plus a liquid antiseptic solvent component, as described previously. If a monovalent alcohol in particular is added as a sterilizing active ingredient to this first kneadable and shapeable compound, then this first compound may be used to mechanically clean an interdental toothbrush on the one hand and to largely sterilize and/or antiseptically clean the brush on the other hand.

The second kneadable and shapeable compound is additionally provided with dental ingredients, disinfectant and antiseptic active ingredients. Although the first shapeable compound preferably contains the solvent component, namely alcohol, in an amount of 1% by weight to 10% by weight, the alcohol component in the second compound may be omitted or reduced.

Whereas the first kneadable and shapeable compound described above is used mainly for cleaning the interdental brush to remove adhering debris, the second kneadable and shapeable compound acts mainly to sterilize the interdental brush and to supply active ingredients which have a cleaning effect for the dental cleaning. This second compound accordingly contains antiseptic agents in particular. Such antiseptic agents are widely used for toothpaste. Amine fluoride and/or stannous fluoride is/are preferably suitable in particular. Amine fluoride and stannous fluoride are known for the fact that these are respected plaque bacteria-inactivating agents and agents to inhibit the formation of new dental calculus. Practically the same effect is also manifested by fluorhexidine, which may also be added as an active ingredient to the two kneadable and shapeable compounds. Furthermore, disinfectant agents may also be added to this compound. The possibility of using water-soluble povidone iodide has been suggested here as being especially preferred. Povidone iodide is available on the market in particular as Betadine® from the company Purdue Pharma L.P.

Although the first compound is used in particular immediately following cleaning of the teeth by inserting the interdental toothbrush into this compound, the second compound is used before the interdental toothbrush is used and/or reused.

The interdental toothbrush-cleaning means according to the invention may preferably also contain polyhexanide as an antiseptic in the second compound. This substance is suitable as a wound antiseptic for treatment of infected wounds in particular. Because of its good tissue tolerability and obvious promotion of wound healing clinically, polyhexanide is especially suitable for treatment of chronic and very sensitive wounds as well as those that are not healing well. Polyhexanide is therefore also suitable in particular for treatment of periodontitis.

It would of course be inconvenient for the user to have two separate containers. On the other hand, the two substances cannot appropriately be mixed together. A single agent having both functions would not be consistent with hygienic concepts. It is therefore proposed according to the invention that a device be used having two separate containers, one for the first and another for the second kneadable and shapeable compound, such that each of the two containers that are separate but are kept together will have separate insertion openings through which the interdental toothbrush can be inserted into the corresponding compound, so that the two compounds can be brought into operative connection with the interdental toothbrush one after the other. FIG. 1a shows symbolically a first container 2 into which an interdental toothbrush is inserted. Purely symbolically, the lower half is shown darker to clarify that this is the first kneadable and shapeable compound. Figure lb shows the interdental toothbrush partially inserted into the compound according to the invention. Finally, FIG. 1c shows how the debris remains behind in the first and optionally also in the second kneadable and shapeable compound.

FIGS. 2a through 2c show how such a device according to the invention might preferably appear. FIG. 2a shows the rear side of the device according to the invention, which is labeled as 1 on the whole. The device comprises two containers, namely a container 2 and a container 2′. Each of the two containers is provided with a closing cap 3 and 3′ for opening and closing the containers. The two containers 2 and 2′ are arranged in a holding device, so that the one container 2 rests at its container bottom on the container bottom of the other container 2′. The holding device 4 consists of a c-shaped clip-type plastic part. The front side of the clip-type plastic part 4 is open while the rear part is closed. This closed wall of the holding device 4 may be designed so that it has a receiving space 6, which holds at least one interdental toothbrush. This receiving space is preferably designed and of dimensions, such that two interdental toothbrushes are accommodated therein. This is shown best in FIG. 4. The interdental toothbrushes are labeled here as 7. The receiving space 6 can be closed by means of a cover 8. Mirrors 11 can either be mounted in the cover 8 or on the inside of one or both caps 3 and/or 3′.

FIG. 3 shows the device according to the invention in an exploded diagram, where it can also be seen that the two containers 2 and 2′ each preferably have multiple compartments 9. Each compartment has its own insertion openings 10. These insertion openings are provided in the closing bottom parts of the closing caps. Each insertion opening 10 opens into another compartment 9. Thus, in the example illustrated here, two compartments are available to the user for each interdental toothbrush. This is appropriate because otherwise, with only a single insertion opening and only one compartment, either this single compartment must be relatively small or otherwise the contents are utilized only in that area in which the interdental brush could be inserted through the corresponding insertion opening. In this way, however, each compartment can be used separately and successively, and only when one compartment is heavily loaded with debris will the next compartment be used. Both the individual compartments and the insertion openings 10 may be adjusted in color, for example, on interdental toothbrushes 7 that are designed with different colors.

The receiving space 6 at the rear is not visible in FIG. 3, but FIG. 3 does show a blister pack 5 situated in this receiving space. This blister pack may be provided with a peel-off film, which then provides access to the two interdental brushes packaged inside. The deep-drawn plastic part may be left in the receiving space and may be used for reinsertion of the used interdental brushes, so that they are well-protected for repeated use. However, it is also possible, instead of providing a blister pack, to accommodate a plastic shell in the receiving space in a form-fitting and/or frictionally locked manner, which has a corresponding shape for receiving the interdental brushes, as illustrated in FIG. 4, for example.

Each insertion opening 10 may advantageously also be covered with a film, which can either be removed or can be punctured by the interdental toothbrush itself.

### LIST OF REFERENCE NUMERALS

1 device
2, 2′ container
3, 3′ cap
4 holding device
5 blister pack
6 receptacle
7 interdental toothbrush
8 cover
9 compartment
10 insertion opening
11 mirror

1. An interdental toothbrush-cleaning system comprising a first and a second kneadable and shapeable compound to be used separately, wherein the first and the second kneadable and shapeable compounds each comprise: hydroxy-propylated polygalactomanan; 75% by weight to 97% by weight bound water; and a liquid antiseptic solvent component, wherein the first kneadable and shapeable compound comprises primarily active ingredients which have a sterilizing effect, and the second kneadable and shapeable compound comprises at least one active ingredient for dental care having disinfectant and antiseptic properties.

2. The cleaning system according to claim 1, wherein the first kneadable and shapeable compound comprises alcohols in an amount of 1% by weight to more than 30% by weight as the active ingredients which have a sterilizing effect and serves to clean the interdental toothbrush and to pick up solid articles adhering thereto.

3. The cleaning system according to claim 1, wherein at least one of the first compound and the second compound comprises an essential oil.

4. The cleaning system according to claim 1, wherein the second kneadable and shapeable compound comprises an antiseptic agent as the active ingredient and serves to dispense the active ingredient to the interdental toothbrush before its use and/or reuse.

5. The cleaning system according to claim 4, wherein the second compound comprises amine fluoride and/or stannous fluoride as the antiseptic ingredient.

6. The cleaning system according to claim 4, wherein the second compound comprises chlorhexidine as the antiseptic ingredient.

7. The cleaning system according to claim 4, wherein the second compound additionally comprises water-soluble povidone iodide as the antiseptic ingredient.

8. The cleaning system according to claim 4, wherein the second compound comprises polyhexanide as the antiseptic ingredient.

9. A device for cleaning interdental brushes using the cleaning system according to claim 1, wherein the device has two separate containers that are held together, one each being provided for the first and second kneadable and shapeable compounds, into which an interdental toothbrush can be inserted through at least one separate insertion opening and can be brought into effective contact with the two compounds one after the other.

10. The device according to claim 9, wherein the two containers are held in a holding device, each container can be closed with its own cap, and the two containers are arranged such that a container bottom of the first container rests on the a container bottom of the second container.

11. The device according to claim 10, wherein the holding device is a c-shaped clip-type plastic part surrounding the two containers jointly.

12. The device according to claim 11, wherein a receiving space for at least one interdental toothbrush that can be closed with at least one cover is provided on the closed wall of the clip-shaped plastic part.

13. The device according to claim 12, wherein at least one of the inside of the cap and the inside of the cover is provided with a mirror surface.

14. The device according to claim 9, wherein the insertion openings are covered with a film before initial use of the device.

15. The device according to claim 9, wherein each container has multiple compartments, caps placed on the container have an equal number of insertion openings and each insertion opening communicates with one compartment.
